(19) United States
(12) Patent Application Publication
(10) Pub. No.: US 2006/0250363 A1
(43) Pub. Date: Nov. 9, 2006

(54) Mouse with image system and method for using the same

(76) Inventor: Pin-Kuan Chou, Hsinchu (TW)

Correspondence Address: LIN & ASSOCIATES INTELLECTUAL PROPERTY, P.O. BOX 2339, SARATOGA, CA, 95070-0339, US

(21) Appl. No.: 11/125,027

(22) Filed: May 9, 2005

(51) Int. Cl. G09G 5/08

(52) U.S. Cl. 345/163

(57) ABSTRACT

The present invention provides a mouse with image system connecting to a computer. The mouse with image system provides a mouse mode for controlling cursor on a computer display and an imaging mode for taking images. The mouse with image system comprises a mouse body, mouse buttons disposed on an upper surface of the mouse body, a mouse displacement sensing system, an image system, a mode switch circuitry, a data transmission interface circuitry and a mode switch component disposed on peripheral side of the mouse body. The mode switch circuitry connects to the mouse displacement sensing circuitry, the image system, the data transmission interface circuitry and the mode switch component. At the moment of starting the computer, users operate the mode switch component to control the mode switch circuitry, so as to select firstly entering the imaging mode. Therefore, it is convenient for users to immediately and directly transmitting images without delay.

### BACKGROUND OF THE INVENTION

1. Field of the Invention

The present invention relates generally to a mouse, and more particularly to a mouse with image system capable of taking images.

2. The Related Art

Nowadays, for the popularization of Internet Network technology, image data is conveniently transmitted through the Internet Network. However, to transmit image data, users must firstly install an image-taking device such as a digital camera to a computer, then download the image data from the image-taking device to the computer, and transmit the image data to another user through the Internet. Such image data transmission operation is complicated and time-consuming. Thus, a mouse with a camera for being conveniently operated as an image-taking device as well as a mouse is provided to solve the problem mentioned above.

U.S. Pat. No. 6,525,306, issued on Feb. 25, 2003, provides such a mouse with a camera. The mouse is operated either in a mouse mode for controlling cursor on a computer display or in an imaging mode for taking images. When the computer is initialized, the computer loads mouse program, and the mouse firstly enters mouse interface to be operated as a common mouse. When to use the imaging mode, users should lift the mouse from a mouse pad or other reference surface, then the mouse is automatically switched into imaging mode to take images and transmit the images to the computer.

If users want the mouse to firstly work in its imaging mode as soon as the computer is started, as mentioned above, as the mouse has no special mode switch device, the mouse can not be switched at that time to satisfy users such need. Users should wait until the computer is started and initialized and the mouse is entered the mouse mode, only then the mouse can be switched into the imaging mode. As a result, making use of the imaging mode is restricted for complicate operation. Furthermore, when users need to use the imaging mode directly and immediately at the moment of the computer being started and entered an operation system interface without delay, the mouse disclosed in the U.S. Pat. No. 6,525,306 can not satisfy users such requirement. Transmission images by such mouse are delayed and time-consuming which are great inconvenience and restrictions for users.

### SUMMARY OF THE INVENTION

It is an object of the present invention to provide a mouse with image system capable of selectively entering the imaging mode or the mouse mode first as required as soon as the computer is started.

To fulfill the above object, the mouse with image system is adapted for connecting to a computer. The mouse with image system comprises a mouse body, a plurality of mouse buttons disposed on a surface of the mouse body, a mouse displacement sensing system, an image system, a data transmission interface circuitry, a mode switch component disposed on a peripheral side of the mouse body and a mode switch circuitry. The mouse displacement sensing system disposed inside the mouse body provides a mouse mode. The mouse displacement sensing system comprises a cursor sensing system and a mouse microprocessor. The cursor sensing system senses the displacement of the mouse. The mouse microprocessor processes the mouse displacement signals into mouse displacement data. The image system disposed inside a mouse body provides an imaging mode. The image system comprises an image sensing system, an analog/digital converter and an image microprocessor. The image sensing system senses images of outer objects and converts the image signals into electrical signals. The analog/digital converter converts the electrical signals into digital signals. The image microprocessor receives the digital signals transmitted from the analog/digital converter and processes the digital signals into image data. The data transmission interface circuitry disposed inside the mouse body connects to the mouse microprocessor and the image processor for transmitting the mouse displacement data or the image data to the computer. The mode switch circuitry disposed inside the mouse body connects to the mouse microprocessor, the image processor, the data transmission interface circuitry and the mode switch component. When the computer is started, the mode switch component is manipulated by users to control the mode switch circuitry for commanding the mouse with image system to selectively enter the mouse mode or the imaging mode firstly and directly as required.

Also disclosed is a method for operating the mouse with image system, comprising the steps of: Starting the computer during which the mouse initializes its interface; operating the mode switch component to command the mouse to selectively enter the mouse mode or the imaging mode, then the mouse displacement data or the image data of the selected mode being transmitted to the computer; and switching the mouse between the mouse mode and the imaging mode by the mode switch component as required.

As mentioned above, the present invention provides a mouse with image system and method for using the same, at the moment of starting the computer, the mode switch component is operated conveniently by users to select firstly entering the mouse mode or the imaging mode. Therefore, it is convenient for users to immediately and directly using imaging mode without delay. After the mouse with image system entering a selected mode, the mode switch component is further manipulated to alternatively switch between the mouse mode and the imaging mode conveniently.

### BRIEF DESCRIPTION OF THE DRAWINGS

A detailed explanation of a preferred embodiment of the present invention will be given, with reference to the attached drawings, for better understanding thereof to those skilled in the art:

FIG. 1 is a perspective view of a mouse with image system according to the present invention;

FIG. 2 is another perspective view of the mouse with image system as shown in FIG. 1;

FIG. 3 illustrates the mouse with image system being applied to a computer;

FIG. 4 is an electrical block diagram of the mouse with image system; and

FIG. 5 is a flowchart of operating the mouse with image system.

### DETAILED DESCRIPTION OF THE PREFERRED EMBODIMENT

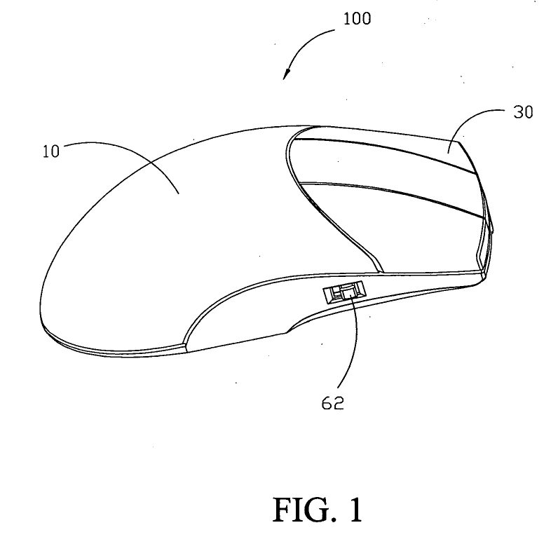

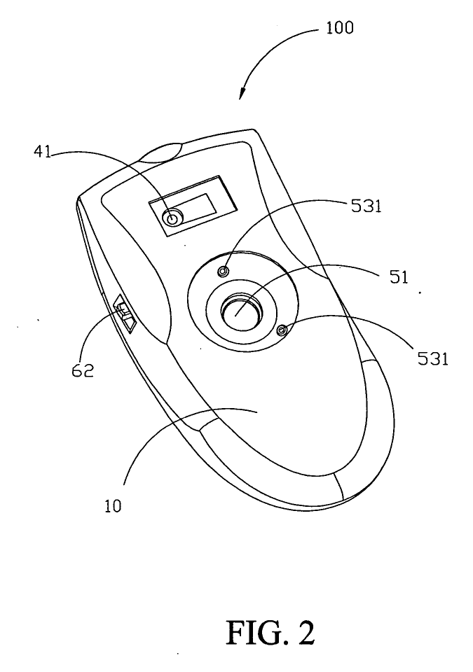

With reference to FIG. 1 and FIG. 2, a mouse with image system comprises a mouse body 10. The upper surface of the mouse body 10 is a cambered surface and shaped for a hand to comfortably receive it. A plurality of mouse buttons 30 is disposed at the front of the upper surface. The mouse buttons 30 comprise a left button functioned for a click operation, a right button functioned for a menu operation and a middle button functioned for a specific operation in conformance with the function of software.

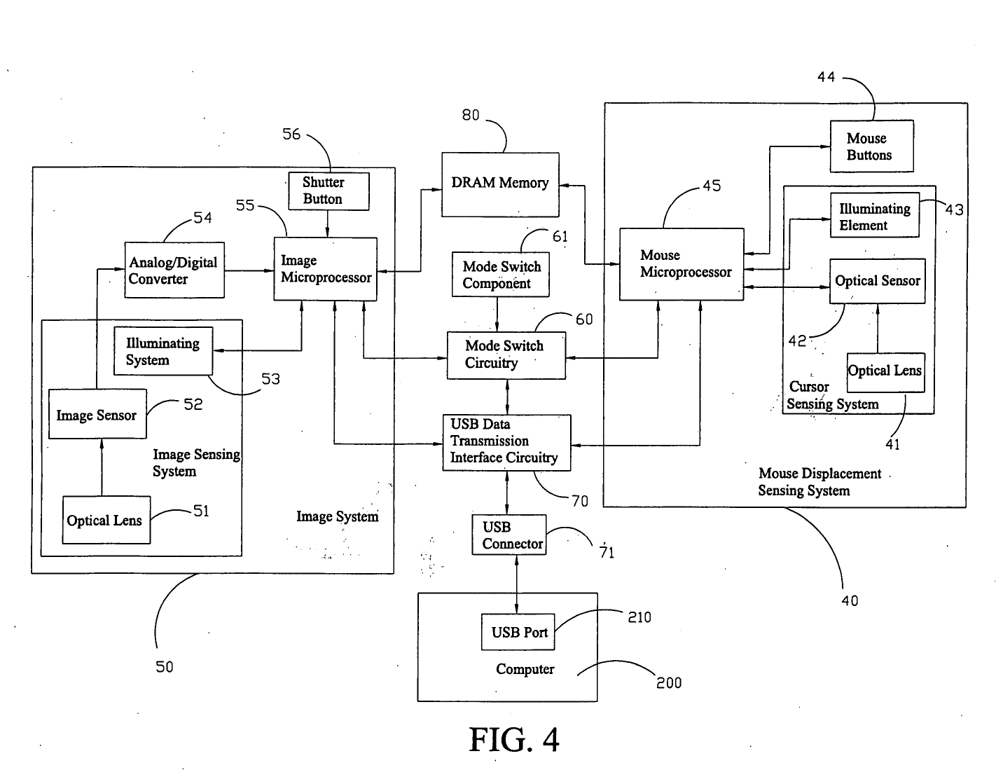

In conjunction with reference to FIG. 4, the mouse with image system 100 further comprises a mouse displacement sensing system 40, a image system 50, a USB data transmission interface circuitry 70, a mode switch circuitry 60 and a DRAM memory 80.

The mouse displacement sensing system 40 is disposed inside the mouse body and provides a mouse mode. The mouse displacement sensing system 40 comprises a cursor sensing system and a mouse microprocessor 45. The cursor sensing system is composed of an optical lens 41, an optical sensor 42 and an illuminating element 43. The optical lens 41 is located and recessed in the bottom surface of the mouse body 10, as shown in FIG. 2. The optical sensor 42 and the illuminating element 43 respectively connect to the mouse microprocessor 45. The mouse buttons 30 connect to the mouse microprocessor 45 so as to control the cursor.

When the mouse with image system 100 is placed and moved on a reference surface, for example, a mouse pad, the illuminating element 43 emits light on the reference surface, and the optical lens 41 receives and transmits the light reflected from the reference surface to the optical sensor 42. The optical sensor 42 transforms the reflected light into electrical signals and then outputs the electrical signals to mouse microprocessor 45. The mouse microprocessor 45 processes and converts the electrical signals into mouse displacement data.

The image system 50 is disposed inside the mouse body 10 and provides an imaging mode. The image system 50 comprises an image sensing system, an analog/digital converter 54 and an image microprocessor 55. The image sensing system comprises an optical lens 51, an image sensor 52 and an illuminating system 53. Referring to FIG. 2, the optical lens 51 is disposed in the middle of the bottom surface of the mouse body 10. The illuminating system 53 comprises a pair of high luminance LED 531 being respectively disposed at the upper and lower lateral sides of the optical lens 51. As shown in FIG. 4, the illuminating system 53 connects to the image microprocessor 55 to provide adequate luminance for ensuring quality of images when using the imaging mode. The optical lens 51 connects to the image sensor 52 and transmits the light reflected from outer objects to the image sensor 52. The image sensor 52 connects to the analog/digital converter 54 and transforms the received reflected light signals into electrical signals for further transmitting the electrical signals to analog/digital converter 54. The analog/digital converter 54 connects to the image microprocessor 55 and converts the electrical signals received from the image sensor 52 to digital signals. The image processor 55 receives and further converts the digital signals to image data.

In the preferred embodiment of the present invention, the image system 50 is a web camera system for taking full-motion images of the outer objects and then transmitting the full-motion images to a computer 200. In this preferred embodiment, a common digital PC camera with a CMOS image sensor is applied to take and transmit full-motion images. The image system 50 further comprises a shutter button 56. The shutter button 56 connects to the image microprocessor 55 and is provided for capturing still images either before or during the full-motion images transmission, a detailed description of which will be provided later.

USB data transmission interface circuitry 70 is disposed inside the mouse body 10 and connects to the mouse microprocessor 45, the image microprocessor 55 and a USB connector 71. The USB connector 71 couples with a USB port 210 of the computer 200 through a USB cable, thus, the mouse displacement data of mouse displacement sensing system 40 and the image data of the image system 50 are respectively transmitted to the computer 200 through the USB data transmission interface circuitry 70.

In the preferred embodiment according to the present invention, other mouse transmission interface standards may be applied to the data transmission interface circuitry, for example, a PS/2 or RS232 standard etc. In this preferred embodiment, a USB data transmission standard is applied, and the power supply of the image system 50 is obtained from the computer 200 through the power wire of the USB cable. Thus, the size of the image system 100 is miniaturized to be compact for omitting an independent power supply system. If other data transmission interface standard is applied, the power supply of the image system 50 should be equipped, for example, an independent power supply system should be applied in the image system 50.

The mode switch circuitry 60 is disposed inside the mouse body 10 and connects to the mouse microprocessor 45, the image microprocessor 55 and the USB data transmission interface circuitry 70. In this preferred embodiment, the mouse with image system 100 further comprises a mode switch component 61. The mode switch component 61 is disposed on a peripheral side of the mouse body 10 and connects to the mode switch circuitry 60. As shown in FIG. 2, the mode switch component 61 is a toggle switch 62 located on a right lateral side of the mouse body. Users manipulate the toggle switch 62 to control the mode switch circuitry 60, so as to control the mouse microprocessor 45 and the image microprocessor 55, thus, the mouse mode or imaging mode is determined while users manipulate the mode switch component 62.

The DRAM memory 80 is disposed inside the mouse body 10 and connects to the image processor 55 and the mouse microprocessor 45, so as to satisfy the large storage requirement of the mouse displacement data and the image data, and to provide a buffer of data transmission.

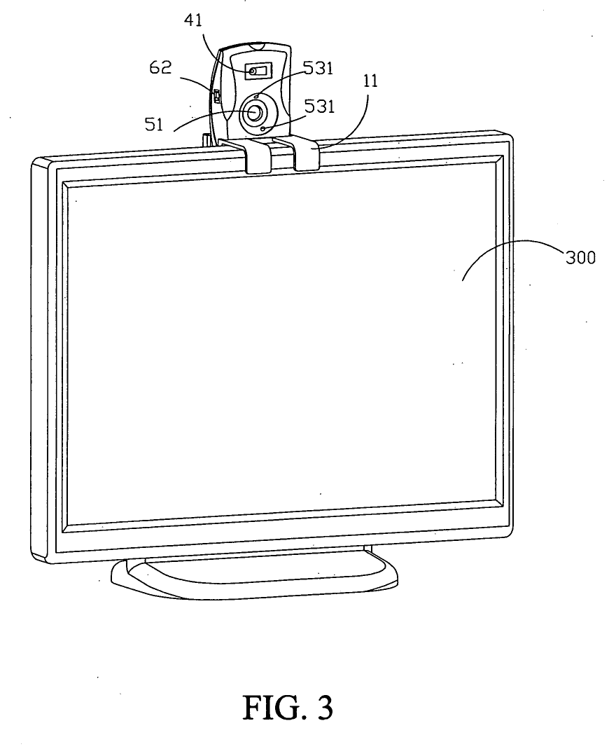

Mostly, the mouse with image system 100 is functioned as a conventional mouse. If the imaging mode is required, users operate the toggle switch 62 to switch the mouse mode to the imaging mode, and meanwhile the mouse mode is off. Referring to FIG. 3, when the mouse with image system 100 is in its imaging mode, a pedestal device is designed to receive the mouse with image system 100. The pedestal device comprises a pair of paw 11 for being stably laid on a display 300 and a receiving cavity for receiving the mouse body 10.

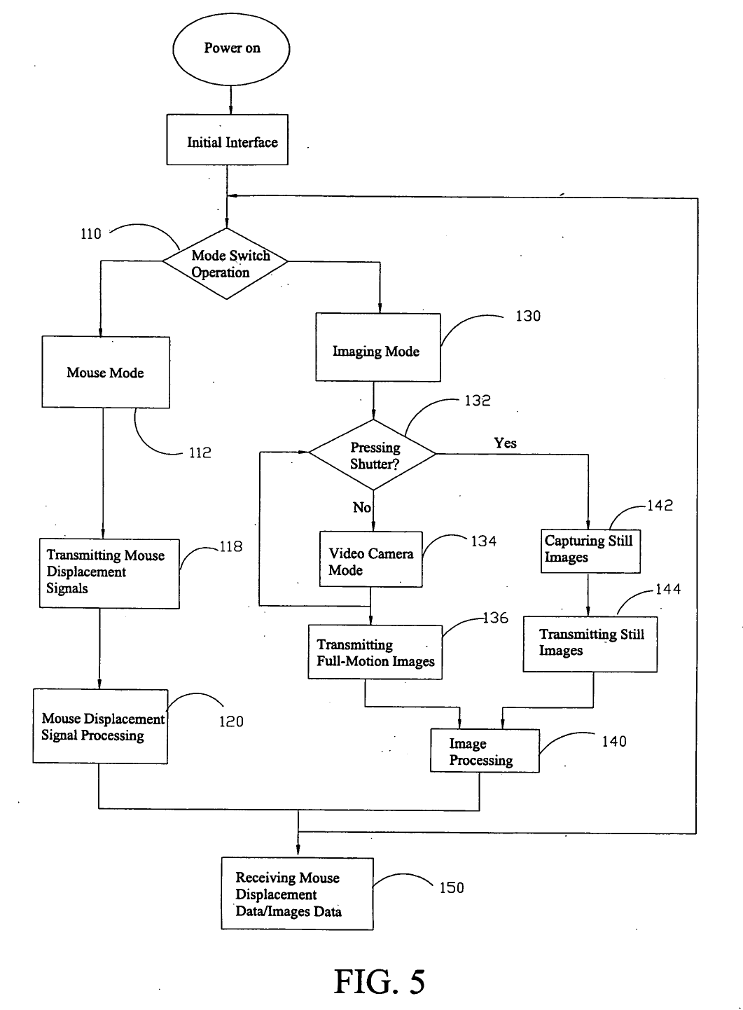

FIG. 5 is a flowchart showing operating method of the mouse with image system 100. When the computer 200 is started, the mouse with image system 100 that connects to the computer 200 enters an initial interface. At this moment, users operate the mode switch component 61 to perform mode switch operation 110. If users select an imaging mode 130, the users should decide whether to press shutter button 132. If the shutter button 56 is pressed, the mouse with image system 100 is operated to capture still images 142 and transmit the capture still images 144 to image microprocessor 55, so as to perform the images processing 140. If the shutter button 56 is not be pressed by users, the imaging mode 130 automatically enters a video camera mode 134, so the mouse with image system 100 is used to take full-motion images and transmit the full-motion images 136 to image microprocessor 55 so as to perform the image processing 140 to obtain video images. Under the two conditions of the imaging mode 130 described above, the processed still images and full-motion images are all transmitted to the computer 200 through the USB data transmission interface circuitry 70 so as to perform further images editing. After entering the video camera mode 134, if users select to press the shutter button 56, the state of taking full-motion images 135 is switched to capture still images 142, so as to satisfy instant requirement of capturing still images of users.

While the computer 200 is started, if users operate the mode switch component 61 to select entering a mouse mode 112, the computer 200 loads mouse interface programs, so the mouse with image system 100 enters mouse operation interface and is operated as a conventional mouse. Meanwhile, the mouse with image system 100 transmits mouse displacement signals 118 to the mouse microprocessor 45, so as to perform mouse displacement signals processing 120. Finally, the computer 200 receives mouse displacement data/image data 150, so as to respectively control cursor displacement and image transmission.

After the mouse with image system 100 enters the mouse mode 112, if users need to transmit full-motion images or capturing still images, users just need to operate the mode switch component 61 to perform mode switch operation 110, and the mouse with image system 100 is switched to the imaging mode 130. Thus, taking/transmitting the full-motion images and still images is achieved. Correspondingly, after the mouse with image system 100 enters the imaging mode 130, users may operate the mode switch component 61 to switch the imaging mode 130 to the mouse mode 112 and perform conventional mouse operation.

As described above, at the moment of the computer 200 starting, users operate the mode switch component 61 to select directly and firstly entering imaging mode 130. Therefore, the mouse with image system 100 satisfies the immediately requirement of taking and transmitting images, which avoids images transmitting delay and restrictions. After the mouse with image system 100 entered a selected mode, users can also operate the mode switch component 61 to control the mouse with image system 100, and the mouse with image system 100 is alternatively switched between the mouse mode and the imaging mode to satisfy an instant requirement of users.

Although a preferred embodiment of the present invention has been described in detail hereinabove, it should be clearly understand that many variations and/or modifications of the basic inventive concepts herein taught which may appear to those skilled in the present art will fall within the spirit and scope of the present invention, as defined in the appended claims.

What is claimed is:

1. A mouse with image system adapted for connecting to a computer comprising:
a mouse body;
a plurality of mouse buttons disposed on a surface of the mouse body;
a mouse displacement sensing system disposed inside the mouse body to provide a mouse mode, the mouse displacement sensing system comprising a cursor sensing system and a mouse microprocessor, the cursor sensing system sensing displacement of the mouse, the mouse microprocessor processing the mouse displacement signals into mouse displacement data;
an image system disposed inside the mouse body to provide an imaging mode, the image system comprising an image sensing system, an analog/digital converter and an image microprocessor, the image sensing system sensing images of outer objects and converting the image signals into electrical signals, the analog/digital converter converting the electrical signals into digital signals, the image microprocessor receiving the digital signals transmitted from the analogy/digital converter and processing the digital signals into image data;
a data transmission interface circuitry disposed inside the mouse body, the data transmission interface circuitry connecting to the mouse microprocessor and the image microprocessor, and transmitting the mouse displacement data or the image data to the computer;
a mode switch circuitry disposed inside the mouse body, the mode switch circuitry connecting to the mouse microprocessor, the image microprocessor, and the data transmission interface circuitry; and
a mode switch component disposed on the mouse body and connected to the mode switch circuitry for commanding the mouse to selectively enter the mouse mode or the imaging mode first when the computer is started.

2. A mouse with image system as claimed in claim 1, wherein said cursor sensing system comprising:
an optical lens disposed inside the mouse body;
an illuminating element connecting to the mouse microprocessor; and
an optical sensor connecting to the optical lens and the mouse microprocessor;
Wherein the illuminating element provides light to a reference surface, the optical lens receives the reflected light from the reference surface and transmits the reflected light to the optical sensor, the optical sensor transforms the reflected light into electrical signals, the mouse microprocessor receives the electrical signals.

3. A mouse with image system as claimed in claim 1, wherein said image sensing system comprising:
an optical lens disposed inside the mouse body; and
an image sensor connecting to the optical lens and the analog/digital converter;
Wherein the optical lens transmits the reflected light from the outer objects to the image sensor, the image sensor transforms the reflected light into electrical signals and transmits the electrical signals to the analog/digital converter.

4. The mouse with image system as claimed in claim 1, wherein the image sensor is CMOS sensor.

5. The mouse with image system as claimed in claim 1, wherein the image system is a web camera system that takes full-motion images of the outer objects and transmits the full-motion images to the computer.

6. The mouse with image system as claimed in claim 5, wherein the image system comprises a shutter button connecting to the image microprocessor.

7. The mouse with image system as claimed in claim 1, wherein the image system comprises a shutter button connecting to the image microprocessor.

8. The mouse with image system as claimed in claim 1, wherein the mode switch component is toggle switch.

9. The mouse with image system as claimed in claim 1, wherein the data transmission interface circuitry is USB transmission interface circuitry.

10. The mouse with image system as claimed in claim 1, wherein further comprises a DRAM memory connecting to the mouse microprocessor and the image microprocessor.

11. A method for operating the mouse with image system claimed as claim 1 comprising the steps of:
starting the computer during which said mouse initializes its interface;
operating the mode switch component to command the mouse to selectively enter the mouse mode or the imaging mode, then the mouse displacement data or the image data corresponding to the selected mode being transmitted to the computer; and
switching the mouse between the mouse mode and the imaging mode by the mode switch component as required.

12. The method as claimed in claim 11, wherein the imaging mode is a video camera mode for taking full-motion images of the outer objects.
